(19) United States
(12) Patent Application Publication
(10) Pub. No.: US 2014/0091891 A1
(43) Pub. Date: Apr. 3, 2014

(54) TRANSFORMER TERMINATION AND INTERCONNECTION ASSEMBLY

(71) Applicants: Mark W. Metzler, (US); Terry J. Milroy, (US)

(72) Inventors: Mark W. Metzler, Davis, IL (US); Terry J. Milroy, Loves Park, IL (US)

(73) Assignee: HAMILTON SUNDSTRAND CORPORATION, Windsor Locks, CT (US)

(21) Appl. No.: 13/632,578

(22) Filed: Oct. 1, 2012

(51) Int. Cl. H01F 27/29

(52) U.S. Cl. 336/192

(57) ABSTRACT

A transformer assembly comprises a magnetic core assembly, a bobbin assembly, a coil winding, a transformer interconnect trace, and a coil winding terminal post. The bobbin assembly includes a coil winding assembly disposed around a portion of the magnetic core assembly. The transformer interconnect trace is fixed to a substrate secured to the transformer assembly proximate the bobbin assembly. The coil winding terminal post receives a coil winding end for electrically connecting the coil winding end to the transformer interconnect trace through the coil winding terminal post.

### BACKGROUND

Assembling and using traditional transformer windings and interconnections can be labor intensive and prone to error. Traditional interconnections require numerous splices of magnet wire to stranded wire to connect the transformer to an external component or circuit. The sheer number of connections, which can be on the order of 30-60 for comparable traditional versions of these example transformers, must be done individually, increasing the chances for missed or crossed connections. The reliability of the transformers can also be affected due to increased likelihood of poor traditional magnet wire to stranded wire splice solder connections.

### SUMMARY

A transformer assembly comprises a magnetic core assembly, a bobbin assembly, a coil winding, a transformer interconnect trace, and a coil winding terminal post. The bobbin assembly includes a coil winding assembly disposed around a portion of the magnetic core assembly. The coil winding is retained in the coil winding assembly and spaced apart from the magnetic core assembly. The transformer interconnect trace is fixed to a substrate secured to the transformer assembly proximate the bobbin assembly. The coil winding terminal post receives a coil winding end for electrically connecting the coil winding end to the transformer interconnect trace through the coil winding terminal post.

A transformer interconnect assembly comprises a plurality of transformer interconnect traces fixed to a substrate, and a corresponding plurality of coil winding terminal posts. Each post has a receiving end for receiving a coil winding end, and a mounting end for electrically connecting the coil winding end to the transformer interconnect trace through the coil winding terminal post.

### BRIEF DESCRIPTION OF THE DRAWINGS

FIG. 1A shows a forward perspective view of an example transformer assembly.

FIG. 1B shows a rear perspective view of the example transformer assembly.

FIG. 2 is an exploded view of the example transformer assembly.

FIG. 3A is a magnified view of a first portion of one embodiment of a transformer interconnect assembly.

FIG. 3B illustrates depicts an exploded view of the transformer assembly with a first example transformer interconnect assembly.

FIG. 3C shows a magnified view of a second portion of one embodiment of the transformer interconnect assembly.

FIG. 4A shows a bobbin assembly with a nested coil winding assembly.

FIG. 4B is an exploded view of the bobbin assembly and nested coil winding assembly.

FIG. 5A is an isometric view of a transformer assembly with a second example of a transformer interconnect assembly.

FIG. 5B is a left-side elevation view of the second example transformer and transformer interconnect assembly.

FIG. 5C is a front elevation view of the second example transformer and transformer interconnect assembly.

### DETAILED DESCRIPTION

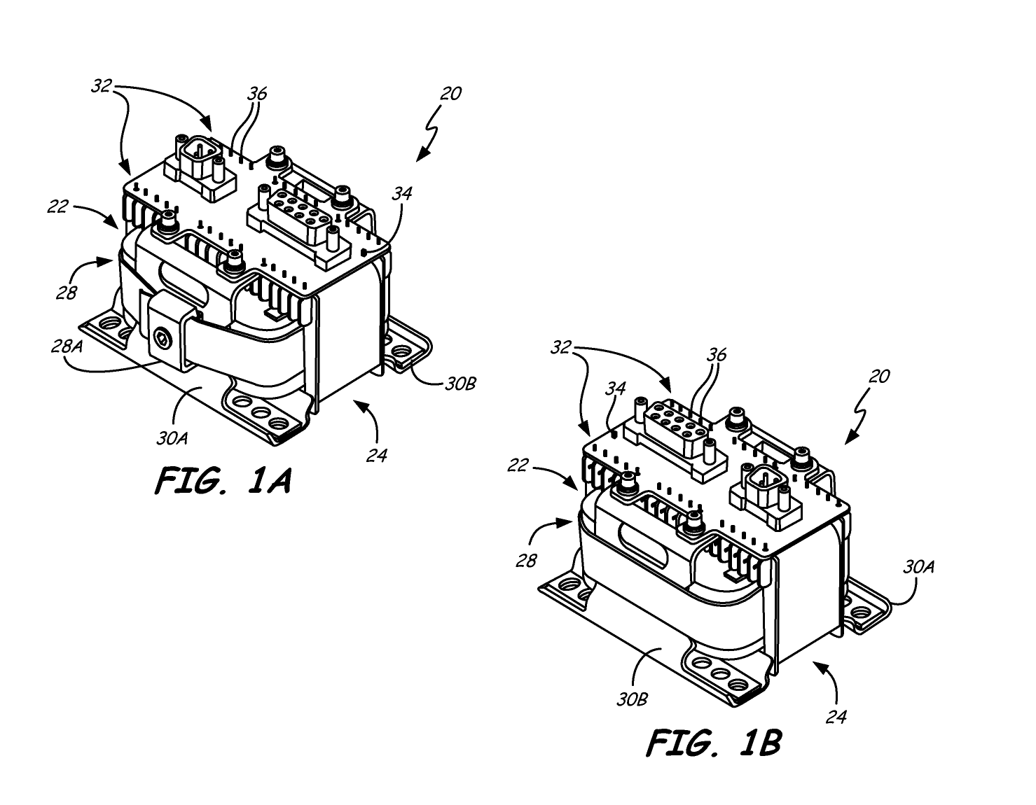

FIGS. 1A and 1B show respective forward and rear perspective views of an example transformer assembly 20, and also include magnetic core assembly 22, bobbin section 24, band 28, buckle 28A, mounting brackets 30A, 30B, coil winding terminal posts 32, substrate 34, and post substrate end 36.

Transformer assembly 20 includes magnetic core assembly 22 and bobbin section 24. Bobbin section 24 can be secured in various ways to magnetic core assembly 22 with band 28 and buckle 28A extending around brackets 30A, 30B for holding magnetic core assembly 22 to bobbin section 24.

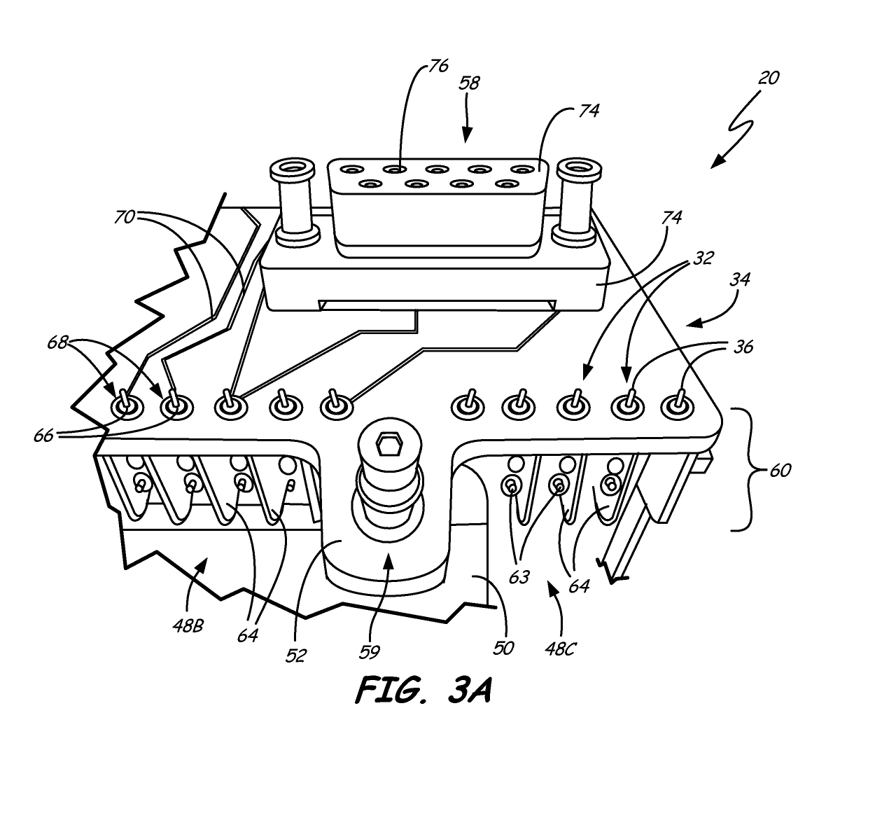

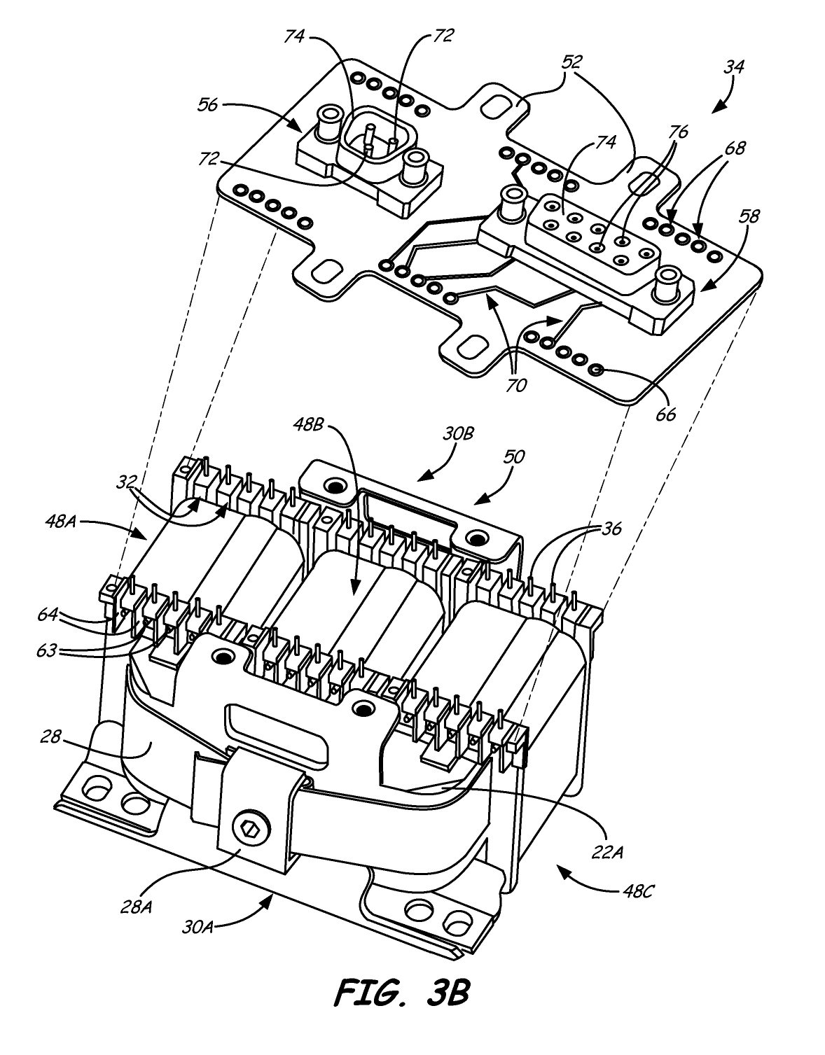

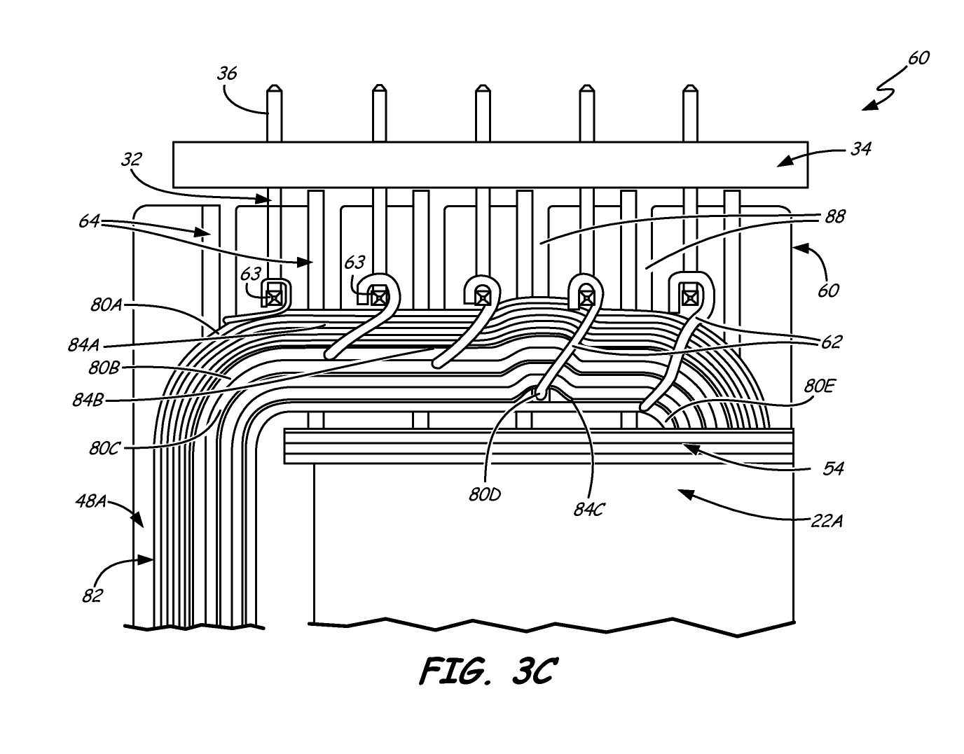

Bobbin section 24 can include one or more bobbin assemblies retaining at least one coil winding assembly (not visible in FIGS. 1A and 1B) around at least one portion of magnetic core 22. In general, each coil winding assembly includes a coil of magnet wire wound several times around a winding body that retains the coil winding around and spaced apart from one or more legs of magnetic core assembly 22. At least some of the coil winding terminal posts 32 receive either a first or second coil winding end (not visible in FIGS. 1A and 1B). Substrate 34 is disposed proximate to bobbin section 24 and terminal posts 32. Substrate 34 includes a plurality of transformer interconnect traces (omitted for clarity) integrally fixed or printed thereon. Substrate end 36 of at least one of the coil winding terminal posts 32 is electrically connected to substrate 34 as described below. As shown in FIG. 3A, each transformer interconnect trace (omitted for clarity from FIGS. 1A and 1B) extends along substrate 34 from a terminal end of the interconnect trace, located at or near the electrical connection with post substrate end 36. Example arrangements and details of various transformer, bobbin, and coil winding assemblies are shown and described below.

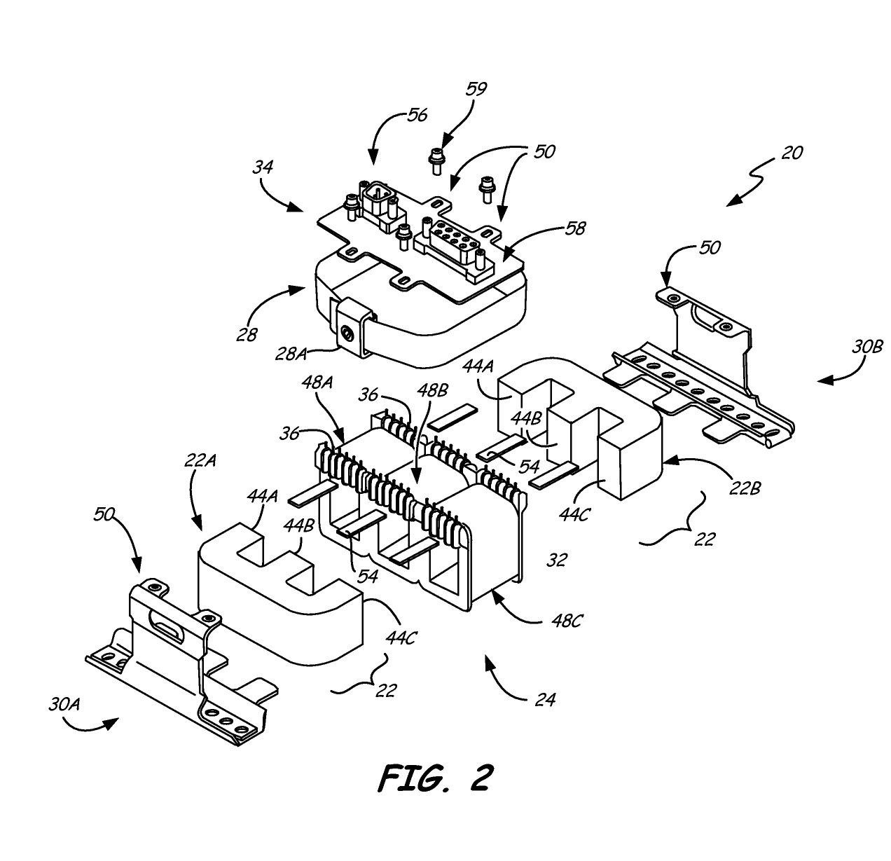

FIG. 2 is an exploded view of the example embodiment of transformer assembly 20 shown in FIGS. 1A and 1B. FIG. 2 also includes magnetic core assembly segments 22A, 22B, bobbin section 24, band 28, buckle 28A, mounting brackets 30A, 30B, coil winding terminal posts 32, substrate 34, post substrate end 36, magnetic core legs 44A, 44B, 44C, bobbin assemblies 48A, 48B, 48C, bracket tab 50, substrate flange 52, shims 54, first electrical interface 56, second electrical interface 58, and transformer interconnect assembly 60.

In this example embodiment of transformer assembly 20, magnetic core assembly 22 includes two core segments 22A, 22B. Each core segment 22A, 22B may be E-shaped with respective pluralities of legs 44A, 44B, 44C arranged adjacent to each other as shown in FIG. 2. Bobbin section 24 includes a plurality of generally rectangular bobbin assemblies 48A, 48B, 48C arranged over respective legs 44A, 44B, 44C of E-shaped core segments 22A, 22B. In this way, each rectangular bobbin assembly 48A, 48B, 48C includes at least one coil winding assembly disposed around a different portion of magnetic core assembly segments 22A, 22B. As seen in more detail below, bobbin assemblies 48A, 48B, 48C can each retain at least one separate coil winding around different legs 44A, 44B, 44C of magnetic core assembly segments 22A, 22B.

Band 28 extends around brackets 30A, 30B to hold rectangular bobbin assemblies 48A, 48B, 48C over respective legs 44A, 44B, 44C of magnetic core segments 22A, 22B. Substrate 34 can be removably fastened to brackets 30A, 30B at tabs 50 and flanges 52 using standard screws 59. Shims 54 can reduce the clearance between core legs 44A, 44B, 44C and bobbin assemblies 48A, 48B, 48C. One or both brackets 30A, 30B can be secured to a component, support frame, or other structure before, during or after assembly of transformer 20.

Each electrical interface 56, 58 can be any type of connector interface suitable for integrating transformer assembly 20 into a particular electrical system. Example families of plug-and-receptacle connector interfaces are described in a commonly assigned U.S. patent application entitled “High Voltage Connector Interfaces”, filed on an even date herewith. Such connector interfaces are suitable for high voltage, high altitude use in aircraft. Other standardized or customized electrical interfaces can also be adapted for use in various embodiments.

In addition to bobbin assembly 48 including at least one coil winding assembly retaining coil windings around and spaced apart from a portion of magnetic core assembly 22 transformer assembly 20 also includes transformer interconnect assembly 60 (shown in FIG. 3A). Transformer interconnect assembly 60 generally includes a plurality of transformer interconnect traces (shown in FIG. 3A) fixed to a substrate 34 to simplify integration with external circuitry and components. Substrate 34 is secured to transformer assembly 20 proximate bobbin assembly 24. Transformer interconnect assembly 60 also generally includes a corresponding plurality of coil winding terminal posts 32 receiving a coil winding end (shown in FIG. 3C) for electrically connecting the coil winding end to the transformer interconnect trace through coil winding terminal post 32. At least one of the plurality of transformer interconnect traces extends along the substrate from an interconnect terminal electrically connected to substrate end 36 of each coil winding terminal post 32.

Assembling and using traditional transformer windings and interconnections can be labor intensive, are prone to error, and are difficult to repair and replace. Traditional interconnections require numerous splices of magnet wire to stranded wire to connect the transformer to an external component or circuit, which are prone to error. The sheer number of connections, which can be on the order of 30-60 for comparable traditional versions of these example transformers, must be done individually, further increasing the chances for missed or crossed connections. The reliability of the transformers can also be affected due to increased likelihood of poor spliced solder connections between magnet wire and stranded wire.

In contrast, a terminal interconnect assembly as described herein can eliminate the need for these splices. The interconnections can be fixed to a substrate, such as a printed wiring board, which replaces separate interconnection wires that have previously been individually spliced. The coil winding terminal posts can be disposed proximate to the substrate, such as on a bobbin assembly, and/or on the substrate itself, to connect the magnet coil windings to interconnection contacts on the substrate. The fixed transformer interconnect traces can be configured in various orientations to form one or more integrated circuits intended to control operation of the transformer assembly relative to the electrical interfaces (e.g., interfaces 56, 58). Two non-limiting example embodiments of a terminal interconnect assembly are described in this specification.

FIG. 3A is a magnified view of one embodiment of transformer interconnect assembly 60. FIG. 3B is an exploded view of transformer assembly 20 with substrate 34 spaced apart from the rest of assembly 20. FIGS. 3A-3C also include coil winding terminal posts 32, substrate 34, post substrate end 36, bobbin assemblies 48A, 48B, 48C, first electrical interface 56, second electrical interface 58, transformer interconnect assembly 60, coil winding ends 62, terminal receiving end 63, coil winding guides 64, substrate contacts 66, substrate mounting holes 68, substrate interconnect traces 70, interface pin contacts 72, interface shells 74, and socket contacts 76.

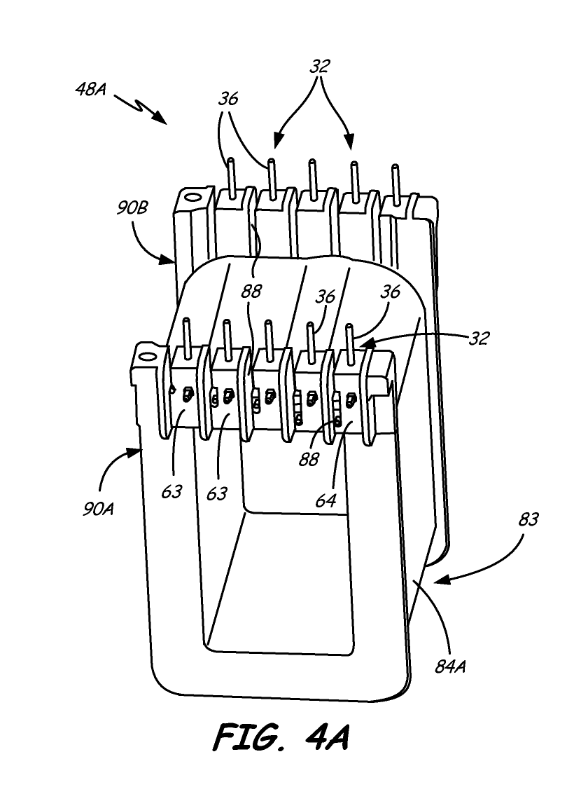

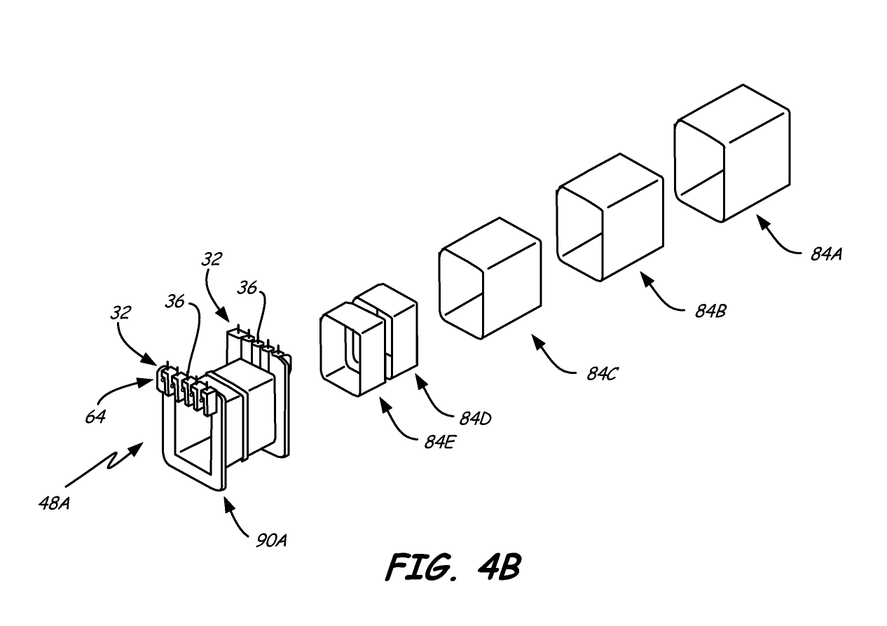

FIGS. 3A-3C illustrate a first part of example transformer interconnect assembly 60 proximate substrate 34 while FIGS. 4A-4B show details around a second part proximate bobbin assemblies 48A, 48B, 48C. As described with respect to FIG. 2, transformer interconnect assembly 60 includes a plurality of coil winding terminal posts 32 disposed proximate to substrate 34 for receiving a corresponding plurality of coil winding ends 62. Coil winding ends 62 extend from at least one coil winding assembly (not visible in FIGS. 3A-3C) disposed in each bobbin assembly 48A, 48B, 48C. Certain embodiments of the bobbin assembly can have a plurality of coil windings, which may be nested as shown in FIGS. 4A-4B.

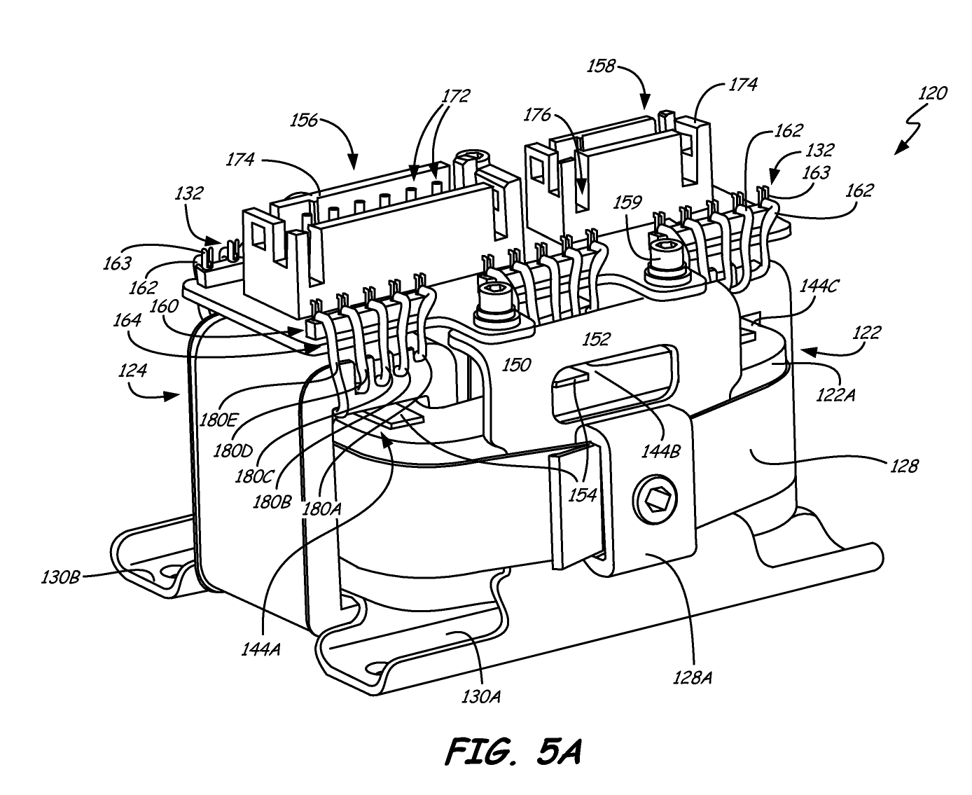

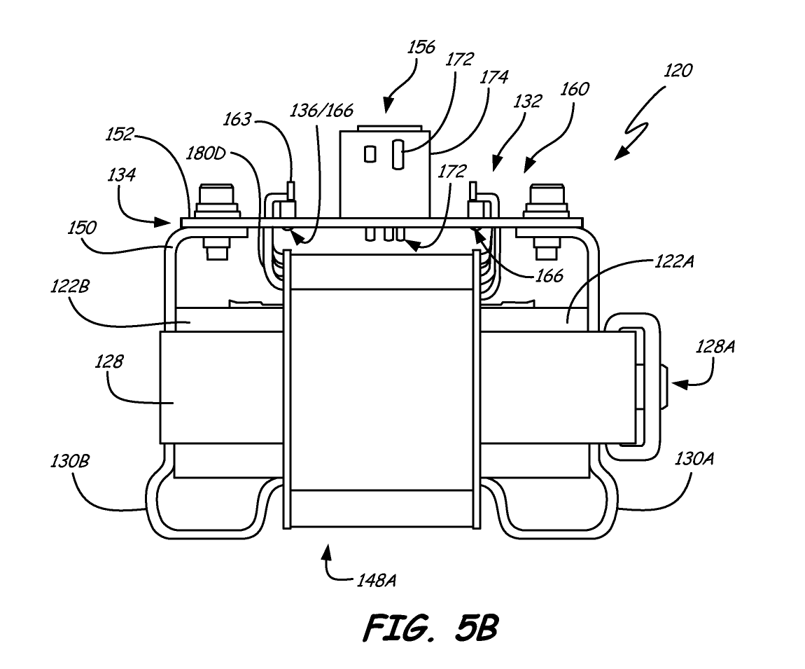

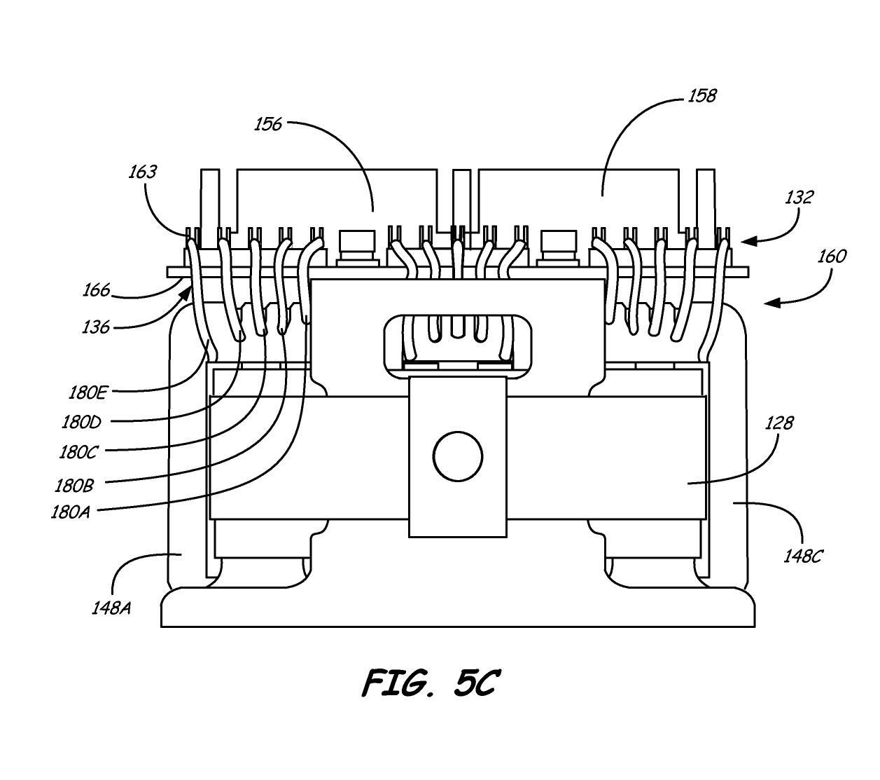

In this first non-limiting example embodiment, coil winding terminal posts 32 each have terminal receiving end 63 and mounting/substrate end 36. Coil winding terminal posts 32 can be mounted to at least one of the multiple bobbin assemblies 48A, 48B, 48C so as to maintain proximity with substrate 34. A plurality of coil winding terminal posts can additionally or alternatively be mounted directly to the substrate, such as is shown in FIGS. 5A-5C.

The plurality of posts 32 can be integrally molded into bobbin assemblies 48A, 48B, 48C to simplify manufacture of the entire assembly. Coil winding ends 62 (shown in FIG. 3C) can extend out from around winding guides 64, which may also be integrally molded to one or more of bobbin assemblies 48A, 48B, 48C. Coil winding ends 62 can be received by winding terminal posts 32 at receiving ends 63.

Terminal post substrate ends 36 are also in electrical contact with substrate 34 by being secured atop bobbin assemblies 48A, 48B, 48C. Each terminal post 32, which may for example be a lead pin, can be electrically connected via mounting/substrate end 36 to a corresponding substrate contact 66. Some or all of these contacts 66 can be disposed in holes 68 formed through substrate 34. Each substrate contact 66 can form a terminal end of at least one fixed transformer interconnect trace 70. Mounting/substrate end 36 can thus extend through a corresponding plurality of holes 68 and engage substrate contacts 66 in order to electrically connect bobbin assemblies 48A, 48B, 48C to interconnect traces 70. To further enhance the connection between terminal posts 32 and corresponding substrate contacts 66, substrate ends 36 can be pressed or soldered in to substrate 34.

Substrate 34 can be generally any type of circuit board with interconnect traces 70 fixed thereto. In this example, substrate 34 is a printed wiring board (PWB) such that interconnect traces 70 are integrated, or printed thereon. Each interconnect trace 70 directly or indirectly connects the respective coil winding terminal posts 32 (via substrate contact 66) to another location in the circuit such as one or both electrical interfaces 56, 58. As noted above, electrical interfaces 56, 58 may be any suitable plug or receptacle configured to engage a corresponding receptacle or plug disposed on a wire harness, circuit board, printed wiring board or any other suitable electrical component (not shown). Here, one or both electrical interfaces 56, 58 can include a plurality of spaced apart pin contacts 72 retained in shell 74 and secured to substrate 34. Pin contacts 72 have a mating socket contact 76 (e.g., either can be a pin or socket) for mating with corresponding mating socket contacts 76 (e.g., either can be a socket or pin) on the corresponding receptacle or plug (not shown). All contacts also have a tail end (not visible in FIGS. 3A-3B) diametrically opposed to mating end, and electrically connected to one or more interconnect traces 70.

One interface in this example, such as first interface 56, can send incoming bus power to transformer assembly 20 (shown in FIG. 2). Second interface 58 can operate as a control for the circuitry of transformer assembly 20, as well as receiving a typically lower outlet voltage suitable for operating one or more aircraft components. In this example, transformer assembly 20 (shown in FIGS. 1A, 1B, and 2) is configured to condition and transform three-phase alternating current, with each coil winding assembly 48A, 48B, 48C dedicated to conditioning and transforming of one of those phases into a useful low-voltage current. Thus, not all interconnect traces 70 need to directly link a tail contact 72 with a coil winding end 62. In certain embodiments, some interconnect traces 70 can direct received signals via one or more tail contacts 72 to control integrated switches or diodes disposed on substrate 34. These switches can be configured to operate different sets of coil windings to achieve different step-down or step-up voltages on each phase. It will also be recognized that FIGS. 3A and 3B only depict a few interconnect traces 70 with many that have been moved or omitted to improve the view of remaining elements. One skilled in the art will be able to readily adapt these teachings to particular arrangements of interconnect traces 70.

Electrical interfaces 56, 58 are shown in this example as being two separate interfaces. However, it will be appreciated that substrate 34 can include a single interface with multiple tail contacts for performing both functions. It will also be recognized that yet other embodiments can include more than two electrical interfaces.

FIG. 3C shows a magnified view of interconnect assembly 60 at a second end of coil winding terminal posts 32. substrate 34, post substrate end 36, bobbin assembly 48A, transformer interconnect assembly 60, coil winding ends 62, terminal receiving end 63, coil winding guides 64, coil windings 80A, 80B, 80C, 80D, 80E, nested coil winding assembly 82, and nested coil winding bodies 84A, 84B, 84C.

As shown in FIGS. 3A-3C, coil winding terminal posts 32 can be integrally molded onto one or more bobbin assemblies 48A, 48B, 48C to maintain proximity to substrate 34. Posts 32 can be electrically connected to substrate 34 and interconnect traces 70 at post substrate end 36. In this example, at least one of the post receiving ends 63 each has coil winding end 62 conductively connected and secured thereto. This may be done by crimping, soldering or any other suitable conductive interface. Coil winding ends 62 are ends of magnet wire wound within example bobbin assembly 48A to form coil windings 80A, 80B, 80C, 80D, 80E retained around core leg 22A. Coil windings 80A, 80B, 80C, 80D, 80E can be nested to form nested coil winding assembly 82 using a plurality of nested coil winding bodies. Bodies 84A, 84B, 84C are visible in this cross-section, but are shown in more detail in FIGS. 4A and 4B.

In conjunction with the connection of coil winding terminal posts 32 to substrate 34 as shown in FIG. 3A-3C, each coil winding 80A, 80B, 80C, 80D, 80E is electrically connected through interconnect traces 70 to one or both electrical interfaces 56, 58. This is a far simpler and more mistake-resistant interconnection arrangement as compared to traditional interconnections requiring individually splicing each coil winding magnet wire to individual interconnect wires or harnesses.

FIG. 4A shows a portion of bobbin assembly 48A with an example nested coil winding body assembly 83. FIG. 4B is an exploded view of nested coil winding body assembly 83. FIGS. 4A and 4B also include coil winding terminal posts 32, post substrate end 36, terminal post receiving ends 63, coil winding guides 64, nested winding bodies 84A, 84B, 84C, 84D, 84E, outlet ports 88, and bobbin body end flanges 90A, 90B.

Nested coil winding body assembly 83 includes in this example, a plurality of nested coil winding bodies 84A, 84B, 84C, 84D, 84E. Each body 84A, 84B, 84C, 84D, 84E supports by nested windings 80A, 80B, 80C, 80D, 80E (shown in FIG. 3C). A separate length of magnet wire can be wound around each of the nested winding bodies 84A, 84B, 84C, 84D, 84E, which are then inserted into one another generally in the arrangement shown in FIG. 4B. As was shown in FIG. 4A, windings 80A, 80B, 80C, 80D, 80D, 80E can be arranged such that coil winding ends 62 can be aligned with outlet ports 88 formed into bobbin assembly 48A, which are then conductively connected to respective terminal post receiving ends 63. Bobbin assembly 48A can also include a bobbin portion with integral end flanges 90A, 90B so that these nested coil winding assemblies 84A, 84B, 84C, 84D, 84E can be placed over an interior portion of the bobbin and retained.

FIG. 5A is an isometric view of a transformer assembly 120 with a second non-limiting example interconnect assembly 160. FIG. 5B is a side elevation view of transformer assembly 120. FIG. 5C is a front elevation view of transformer assembly 120. FIGS. 5A-5C also include magnetic core assembly 120 with segments 122A, 122B, bobbin section 124, band 128, buckle 128A, brackets 130A, 130B, coil winding terminal posts 132, substrate 134 post substrate ends 136, core legs 144A, 144B, 144C, bobbin assemblies 148A, 148B, 148C, bracket tabs 150, substrate flanges 152, dielectric shims 154, electrical interfaces 156, 158, coil winding ends 162, post receiving ends 163, substrate contact 166, electrical interface pin contacts 172, interface shells 174, socket mating ends 176, and coil windings 180A, 180B, 180C, 180D, 180E.

FIGS. 1A, 1B, and 2 show a first example embodiment of transformer assembly 20 with magnetic core assembly 22 and bobbin section 24 with a plurality of bobbin assemblies retaining at least one coil winding assembly around at least one portion of magnetic core assembly 22. FIGS. 5A, 5B, and 5C show a similar arrangement of transformer assembly 120 with magnetic core assembly segments 122A, 122B and bobbin section 124 secured via band 128 extending around brackets 130A, 130B. Substrate 134 can be removably fastened to brackets 130A, 130B at tabs 150 and flanges 152 using standard screws 159 over bobbin assemblies 148A, 148B, 148C. Dielectric shims 154 reduce clearance between core legs 144A, 144B, 144C and bobbin assembly 148A, 148B, 148C. Other like reference numbers correspond to similar arrangements described with respect to the first non-limiting example above.

Similar to the first example, each bobbin assembly 148A, 148B, 148C can include one or more coil winding assemblies. These coil winding assemblies may be nested as shown in FIGS. 4A and 4B with one or more coil windings 180A, 180B, 180C, 180D, 180E each wound several times around a respective one or more legs 144A, 144B, 144C of E-shaped core segments 122A, 122B. As was the case in the first example embodiment, transformer interconnect assembly 160 includes a plurality of coil winding terminal posts 132 disposed proximate to substrate 134 for receiving a corresponding plurality of coil winding ends 162. While the previous example showed transformer interconnect assembly 60 with posts 32 mounted to at least one of the multiple bobbin assemblies 48A, 48B, 48C, this second non-limiting example embodiment shows the plurality of coil winding terminal posts 132 mounted directly onto substrate 134 via substrate contacts 166. In this example, substrate ends 136 of posts 132 can be integral with substrate contacts 166

In the previous example embodiment, FIG. 3A shows transformer interconnect trace 70 extending from a terminal end of the interconnect trace (e.g. substrate contact 66) along substrate 34. This second example embodiment shown in FIGS. 5A-5C can include a similar arrangement of a plurality of transformer interconnect traces (omitted for clarity) integrally fixed or printed onto substrate 134, which connect respective coil winding terminal posts 132 via substrate contacts 166) to another location on the circuit. These interconnect traces directly or indirectly join coil winding ends 162 through the circuit to one or both electrical interfaces 156, 158. Electrical interfaces 156, 158 may be a plug or receptacle configured to engage a corresponding receptacle or plug disposed on a wire harness, circuit board, printed wiring board or any other suitable electrical component as described above (not shown). These example electrical interfaces 156, 158 show different arrangements of pin contacts 172, shells 174, and socket contact mating ends 176 as compared to the earlier example. As explained above, the electrical interfaces (including interfaces 156, 158) can be a standardized or customized interface dependent on the particular electrical system into which the particular embodiment of the transformer assembly is being installed.

Instead of the substrate contact being disposed in a mounting hole (e.g. mounting hole 68 in FIG. 3B), substrate contact 166 in this second example embodiment is disposed directly at the base of terminal posts 132 (post terminal end 166). As a result, the one or more coil windings 180A, 180B, 180C, 180D extend farther upward and over the top of substrate 134. Winding guides 164 in this example can be formed as grooves along the sides of substrate 134 to direct and retain coil windings 180A, 180B, 180C, 180D, 180E in place proximate winding ends 162. Coil winding ends 162 can then be secured directly to post receiving ends 163 on substrate 134 to complete the direct connection between coil windings 180A, 180B, 180C, 180D, 180E and the integrated circuit containing electrical interfaces 156, 158.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A transformer assembly comprising:
a magnetic core assembly;
a bobbin assembly including at least one coil winding assembly disposed around a portion of the magnetic core assembly;
a coil winding retained in the at least one coil winding assembly and spaced apart from the portion of the magnetic core assembly;
a transformer interconnect trace fixed to a substrate, the substrate secured to the transformer assembly proximate the bobbin assembly; and
a coil winding terminal post receiving a coil winding end for electrically connecting the coil winding end to the transformer interconnect trace through the coil winding terminal post.

2. The transformer assembly of claim 1, comprising a plurality of coil winding terminal posts each receiving a terminal end of one of a plurality of coil windings.

3. The transformer assembly of claim 2, wherein the plurality of coil winding terminal posts are integrally molded with the bobbin assembly.

4. The transformer assembly of claim 2, wherein the plurality of coil winding terminal posts are secured directly to the substrate.

5. The transformer assembly of claim 1, comprising a plurality of bobbin assemblies each disposed around different portions of the magnetic core assembly.

6. The transformer assembly of claim 5, wherein each of the plurality of bobbin assemblies retains at least one separate coil winding around different legs of the magnetic core assembly.

7. The transformer assembly of claim 1, wherein the magnetic core assembly comprises an E-shaped core segment having a plurality of legs.

8. The transformer assembly of claim 1, wherein the bobbin assembly includes a plurality of nested coil winding assemblies.

9. The transformer assembly of claim 1, wherein the substrate is a printed wiring board (PWB).

10. The transformer assembly of claim 1, wherein the substrate includes at least one standardized interface for electrically connecting the transformer assembly to an external component or electrical bus.

11. A transformer interconnect assembly comprising:
a plurality of transformer interconnect traces fixed to a substrate; and
a corresponding plurality of coil winding terminal posts, each post having a receiving end for receiving a coil winding end, and a mounting end for electrically connecting the coil winding end to the transformer interconnect trace through the coil winding terminal post.

12. The transformer interconnect assembly of claim 11, wherein the plurality of coil winding terminal posts are secured to at least one bobbin assembly.

13. The transformer interconnect assembly of claim 12, wherein the at least one bobbin assembly includes at least one coil winding assembly.

14. The transformer interconnect assembly of claim 13, wherein the at least one coil winding assembly includes a plurality of nested coil windings.

15. The transformer interconnect assembly of claim 11, wherein the plurality of posts each have a winding receiving end and a substrate end.

16. The transformer interconnect assembly of claim 15, wherein each post substrate end contacts a conductive substrate contact disposed in a corresponding plurality of holes in the substrate.

17. The transformer interconnect assembly of claim 15, wherein the substrate contact forms a terminal end of at least one of the transformer interconnect traces fixed to the substrate.

18. The transformer interconnect assembly of claim 16, wherein at least one of the plurality of post substrate ends is soldered to the conductive substrate contact.

19. The transformer interconnect assembly of claim 11, wherein the substrate is a printed wiring board (PWB).

20. The transformer interconnect assembly of claim 12, wherein coil winding guides are disposed on the sides of the bobbin adjacent the posts.
